(19) United States
(12) Patent Application Publication
(10) Pub. No.: US 2006/0167835 A1
(43) Pub. Date: Jul. 27, 2006

(54) Optimization-based media allocation

(75) Inventors: Vikram Aggarwal, Hawthorne, NY (US); Michelle X. Zhou, Briarcliff Manor, NY (US); Zhen Wen, Chappaqua, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 11/031,951

(22) Filed: Jan. 7, 2005

(51) Int. Cl. G06F 17/30; G06F 7/00

(52) U.S. Cl. 707/2

(57) ABSTRACT

Improved media allocation techniques for use in accordance with information-seeking systems are provided. For example, in one aspect of the invention, a technique for allocating media to present data content for a response to a query comprises the following steps/operations. Data content suitable for generating a response to the query is determined. One or more media for presenting at least a portion of the response (e.g., at least a portion of the intended data content) are dynamically allocated. Media allocation is modeled as an optimization operation which attempts to balance context-based allocation constraints. The optimization operation may also attempt to achieve the desired presentation of intended data content.

### RELATED APPLICATION

The present invention is related to the invention described in U.S. patent application Ser. No. 10/969,581, filed Oct. 20, 2004 and entitled “Optimization-Based Data Content Determination,” the disclosure of which is incorporated by reference herein.

### FIELD OF THE INVENTION

The present invention generally relates to information-seeking systems and, more particularly, to optimization-based techniques for media allocation problems in such information-seeking systems.

### BACKGROUND OF INVENTION

Given a set of data, there may be multiple ways for a computer system to present such data to an intended user. The present invention focuses on media allocation, a process that decides which media, such as graphics or speech, best convey the intended data. Such a process is often context sensitive (e.g., sensitive to presentation tasks and content), and subject to unanticipated cross-content, cross-media effects. For example, the choice of using a particular medium to convey a piece of data may affect the media choice for presenting another related piece of data.

Ideally, it would be desirable to tailor the decision of which media to use to the user interaction context, including the characteristics of the data to be conveyed (e.g., spatial data are best presented using visual media), the properties of available media (e.g., in a mobile environment, rich graphics media may not be available), user presentation preferences (e.g., some users prefer visual presentation while others like verbal presentations), and various presentation design constraints. For example, it would be desirable to convey all similar data using similar medium/media to maintain the desired presentation consistency.

Since so many factors such as what data to be presented and what media are available are only known at run time, it would be desirable for the computer system to tailor its media allocation decision to all these factors dynamically. However, since these factors often interact with each other (e.g., using the most suitable medium to convey a piece of data may violate a presentation consistency constraint), it is a challenge to balance all these factors dynamically so that all of these constraints can be accommodated.

Previously, researchers and practitioners have experimented with a rule-based or schema-based approach to media allocation. However, these approaches normally handle one constraint at a time and do not consider how the constraints themselves may affect one another. As a result, the media allocation result may not be desirable.

In short, when determining which media best convey the intended data for a user query, it would be desirable to consider a number of factors, including data properties, media properties, user preferences, and presentation design constraints. Generally, any subtle variations in these factors, such as changes in data volume or data relationships, may require different media to be used, which in turn prompt different types of responses.

However, to handle all the situations described above and all their possible variations systematically, it is impractical to use a rule-based or schema-based approach, which would require an exhaustive permutation of media allocation rules or plans.

Accordingly, techniques are needed for providing improved media allocation techniques for creating better information-seeking systems.

### SUMMARY OF THE INVENTION

The present invention provides improved media allocation techniques for use in accordance with information-seeking systems.

For example, in one aspect of the invention, a technique for allocating media to present data content for a response to a query comprises the following steps/operations. Given the data content for generating a response to the query, one or more media for presenting at least a portion of the response (e.g., at least a portion of the intended content) are dynamically allocated. Media allocation is modeled as an optimization operation which attempts to balance context-based allocation constraints. The optimization operation may also attempt to achieve the desired presentation of intended data content.

Dynamically allocating one or more media may further comprise modeling the context-based allocation constraints as feature-based desirability metrics. The feature-based metrics may measure the desirability of one or more data-media mappings (i.e., assigning one or more media to convey a piece of intended data content). The invention may measure one or more of the following values (but is not limited to only these values): a task-media compatibility value, a user-media compatibility value, a data-media compatibility value, a recallability value, an affordance value, a presentation ordering value, a data dependency value, and a presentation consistency value.

Further, dynamically allocating one or more media may further comprise formulating the feature-based metrics using contextual information, such as at least one of query information, a conversation history, a user model, and an environment model such as, but not limited to, what device is in use and the resolution of the display of the device.

Still further, dynamically allocating one or more media may further comprise performing the optimization operation such that the desirability metrics are maximized for one or more data-media mappings. The optimization operation may comprise a graph-matching technique.

Advantageously, in one embodiment, the invention provides an optimization-based framework that can dynamically allocate proper media based on an interaction context, such as the specific user preferences and given presentation resources. Further, advantageously, the invention may always attempt to find the most desirable media allocation by balancing all relevant constraints in context.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an intelligent, context-sensitive information-seeking system employing a media allocation component, according to one embodiment of the present invention;

FIG. 2 is a diagram illustrating a media allocation framework, according to one embodiment of the present invention;

FIG. 3A is a diagram illustrating a representation of a set of input data objects, according to one embodiment of the present invention;

FIG. 3B is a diagram illustrating data features and definitions, according to one embodiment of the present invention;

FIG. 4A is a diagram illustrating a representation of a set of input media objects, according to one embodiment of the present invention;

FIG. 4B is a diagram illustrating media features and definitions, according to one embodiment of the present invention;

FIG. 5 is a diagram illustrating a process for modeling a data-media mapping desirability metric, according to one embodiment of the present invention;

FIG. 6 is a diagram illustrating a graph-matching methodology for performing media allocation, according to one embodiment of the present invention;

FIGS. 7 and 8 illustrate an example of data mappings and output presentations, according to one embodiment of the present invention; and

FIG. 9 is a diagram illustrating a computer system suitable for implementing an information-seeking system, according to one embodiment of the present invention.

### DETAILED DESCRIPTION OF PREFERRED EMBODIMENTS

It is to be understood that while the present invention will be described below in the context of exemplary information-seeking applications such as a real-estate application, the invention is not so limited. Rather, the invention is more generally applicable to any application in which it would be desirable to provide optimization-based media allocation techniques and services. Further, the invention is more generally applicable to any application in which it would be desirable to provide quality presentations of information or such presentation service.

As used in the following context, we first define the following terms. We use the term “data objects” to broadly refer to any type of data content that is intended to be presented (e.g., a list of house listings residing in a real-estate database or a list of hotels existing on a website). We use the term “media objects” broadly to refer to any type of media that is available to be used to present the data content, such as but not limited to speech, text, and graphics. We also use the term “context” to refer to the situation where the presentation of the intended data content is given. This may include information, such as but not limited to, the tasks that users are performing, the conversation context that has been established during the user-computer interaction, the user model including user preferences and interests, and the environment model including device properties.

As will be explained in illustrative detail below, the present invention provides a framework, system, and methods for providing context-sensitive, extensible components using dynamic media allocation. That is, the invention provides an optimization-based framework for media allocation, which can dynamically determine the most suitable media allocation by balancing all relevant constraints, including data-media capability (e.g., visual media are allocated to convey spatial data) and presentation design constraints (e.g., usage of suitable media). More particularly, the invention provides methods for modeling various media allocation constraints uniformly as extensible, feature-based quantitative metrics. Further, optimization-based algorithms are provided for balancing all relevant allocation constraints, including cross-data, cross-media allocation constraints to obtain the desired media allocation. Still further, an intelligent, context-sensitive information-seeking system is provided that can generate multimedia responses tailored to user interaction situation using a dynamic media allocation module.

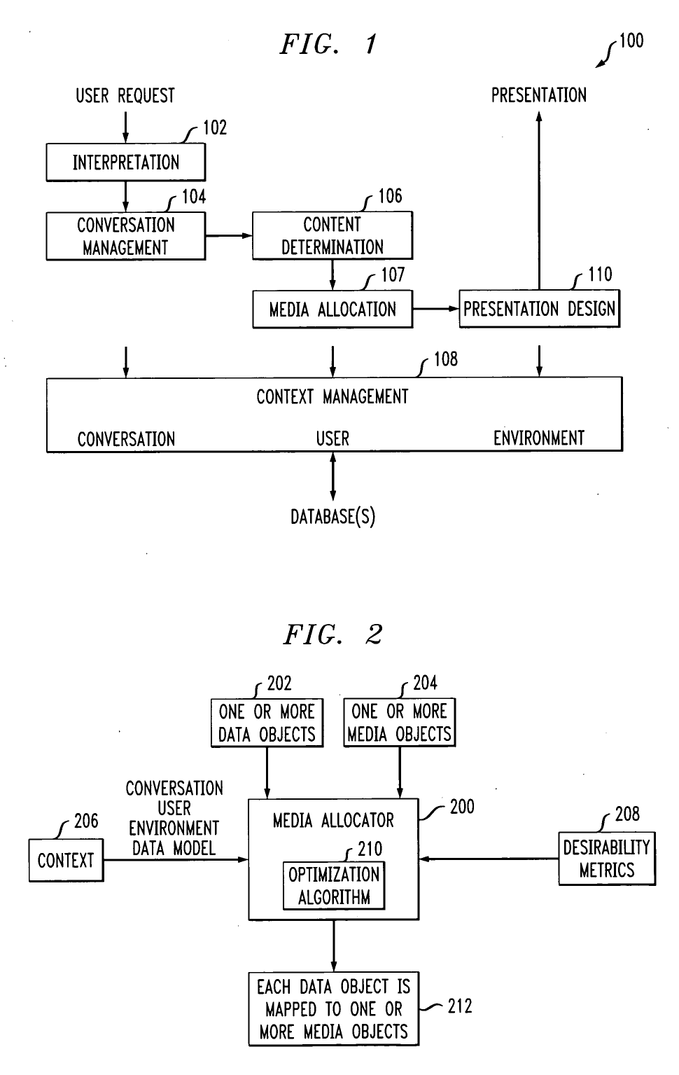

Referring initially to FIG. 1, a diagram illustrates an intelligent, context-sensitive information-seeking system employing a media allocation component, according to one embodiment of the present invention. It is to be appreciated that such a system may also be referred to as a “conversation system” since a sequence of one or more queries and one or more responses between a user and the system may generally be referred to as a conversation.

As shown, information-seeking system 100 comprises interpretation module 102, conversation management module 104, content determination module 106, media allocation module 107, context management module 108 and presentation design module 110.

While the invention is not limited thereto, in one embodiment, techniques described in K. Houck, “Contextual Revision in Information-Seeking Conversation Systems,” ICSLP 2004, and/or in J. Chai et al., “Context-based Multimodal Input Understanding in Conversation Systems,” the disclosures of which are incorporated by reference herein, may be used by interpretation module 102. Further, in one embodiment, techniques described in S. Pan, “A Multi-layer Conversation Management Approach for Information-Seeking Applications,” ISCLP 2004, the disclosure of which is incorporated by reference herein, may be used by conversation management module 104.

Also, in one embodiment, techniques described in the above-referenced J. Chai et al., “Context-based Multimodal Input Understanding in Conversation Systems” article may be used by context management module 108. Still further, in one embodiment, techniques described in M. Zhou et al., “Automated Authoring of Coherent Multimedia Discourse in Conversation Systems” ACM MM 2001, the disclosure of which is incorporated by reference herein, may be used by presentation design module 110.

Furthermore, in one embodiment, techniques described in U.S. patent application Ser. No. 10/969,581, filed Oct. 20, 2004 and entitled “Optimization-Based Data Content Determination,” the disclosure of which is incorporated by reference herein, may be used by content determination module 106.

It is to be understood that the above references cited for techniques that may be employed by the various components are merely examples of techniques that such components may employ. That is, such components are not limited to implementing such example techniques.

The input to system 100 is a user request, given in one or more forms (e.g., through a graphical user interface or by speech and gesture). Given such a request, interpretation module 102 is employed to understand the meaning of the request. Based on the interpretation result, conversation management module 104 decides the suitable system actions at a high level. Depending on the context, it may decide to honor the user request directly by presenting the requested data or it may choose to ask the user additional questions. Since a high-level system act does not describe the exact content to be presented, it is then sent to content determination module 106 to be refined.

Content determination module 106 decides the proper data content of a response based on the interaction context (e.g., how much data is retrieved based on the current user query and the available presentation resource such as time and space). Context management module 108 manages and provides needed contextual information for making various decisions (e.g., the user interests and preferences). While not limited thereto, there are three common types of contexts: conversation context; user context; and the environment context. Such information may be stored in one or more databases. The conversation information records the sequences of user requests and the computer responses. The user information includes user preferences and interests. The environment information includes the information about the system environment, e.g., what type of display is used.

After the data content is determined, media allocation module 107 allocates different media to convey the intended data (in the form of one or more data-media mappings), in accordance with principles of the present invention to be described in illustrative detail below. Such results are then sent to presentation design module 110 to be presented.

Referring now to FIG. 2, a diagram illustrates a media allocation framework, according to one embodiment of the present invention. More particularly, FIG. 2 depicts an example embodiment of an optimization-based media allocation framework.

The input to framework 200 includes a set of one or more data objects 202 to be conveyed and a set of one or more available media objects 204. For example, the data objects may be a set of houses requested by a user to be presented, and the media objects include available media to be used such as speech, text, and graphics. The framework exploits various contextual information 206 coming from different sources. This may include, but is not limited to, conversation context, user context, environment context, and data model. Such contextual information is stored in one or more databases.

To provide the desired extensibility, framework 200 uses a set of feature-based, quantitative metrics 208 to model various context-sensitive media allocation constraints. Specifically, these metrics dynamically measure the desirability of one or more data-media mappings. As used herein, a data-media mapping refers to a mapping between a data object and one or more media objects (e.g., speech and graphics). For example, when presenting a set of houses to a user, the images of houses (data) are mapped to graphics (a medium), while the house prices (data) are mapped to text (medium).

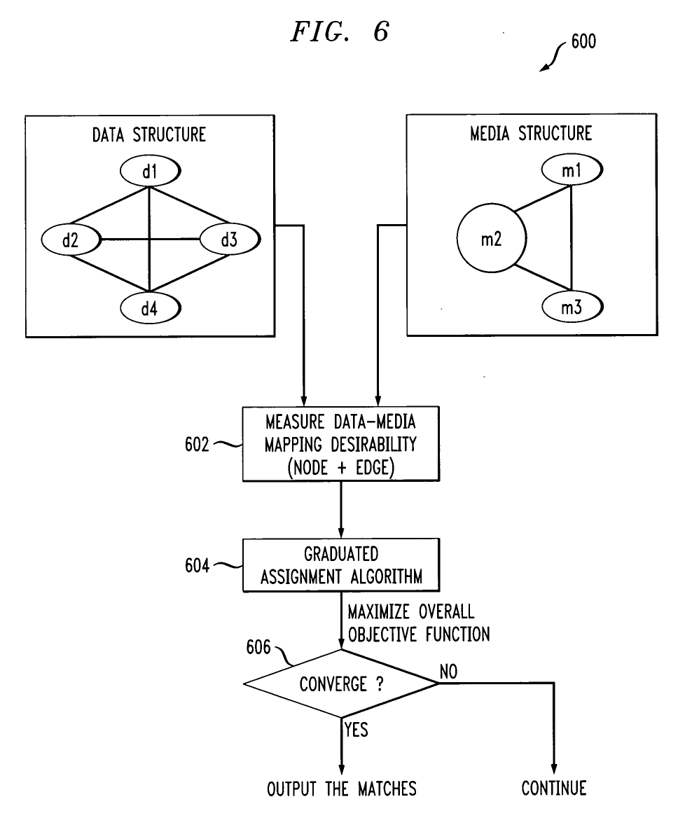

Moreover, framework 200 uses an optimization-based algorithm 210 (e.g., as described in detail below in the context of FIG. 6) that uses these metrics to map every data object to one or more media objects such that an overall desirability of each mapping is maximized. The output from media allocation module 200 is a set of data-media mappings 212.

We now provide some example embodiments of implemented context representations.

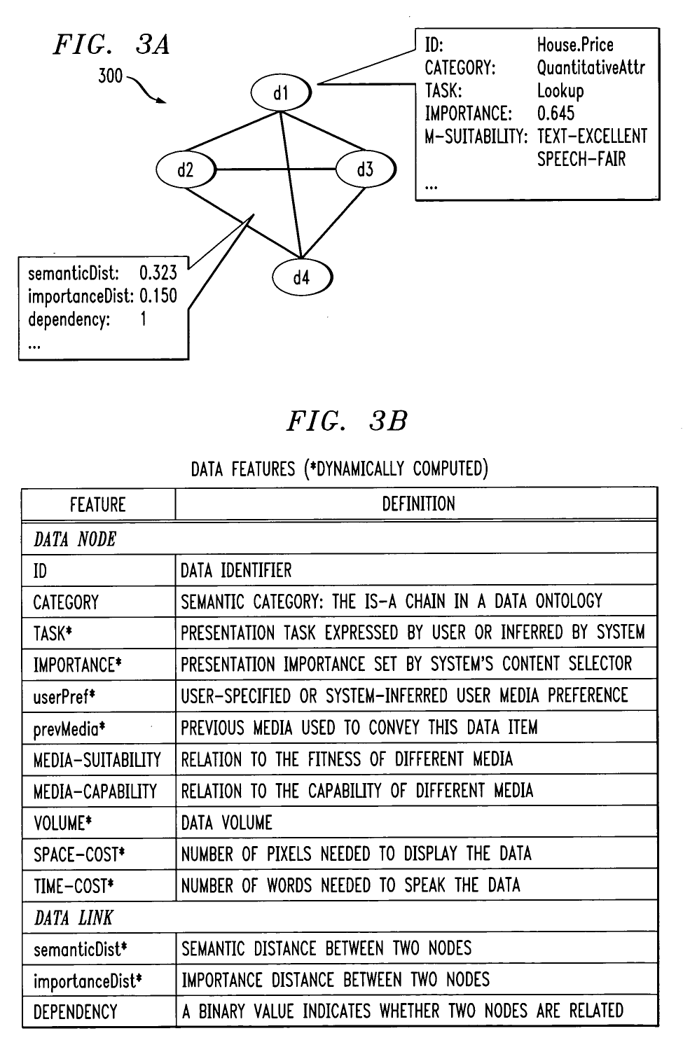

Referring now to FIG. 3A, a diagram illustrates a representation of a set of input data objects, according to one embodiment of the present invention. More particularly, FIG. 3A describes an example embodiment of a structure 300 representing a set of data objects to be presented. In this structure, each node represents a data item to be presented (e.g., d1, d2, d3 and d4), and each link (line connecting each node) denotes the relationships between two items. Each node/link is annotated using a set of presentation-related data features. Such annotation may be as described in the above-cited U.S. patent application Ser. No. 10/969,581, and in Y. Arens et al., “The Knowledge Underlying Multimedia Presentations,” Intelligent Multimedia Interfaces, chap. 12, pp. 280-306, 1993, the disclosure of which is incorporated by reference herein.

Assume, in a real estate information-seeking system application, that node d1 denotes “Price,” and is associated with features like semantic category (category), presentation task (task), and presentation importance (importance). In addition, assume that link (d2, d4) is attached with features such as “semanticDist” (the semantic distance of two nodes) and “importanceDist” (the difference in their presentation importance). While not limited thereto, FIG. 3B lists common node/link features that may be used by the system. As an example embodiment, a data ontology may be defined to encode all static data feature values (e.g., media-suitability).

Normally, an information-seeking system (e.g., the example system described in FIG. 1) dynamically builds such a structure after the system determines the data content to be conveyed. For each intended content item, the system creates a node and extracts all its features from different sources. For example, the system may query a data ontology to obtain the semantic category of a data object, while receiving the presentation importance from the content selector. Content determination module 106 (FIG. 1) dynamically computes the presentation importance for all data items during its content selection process. To build a connected graph, the system links every two nodes and computes the link features using the relevant node features.

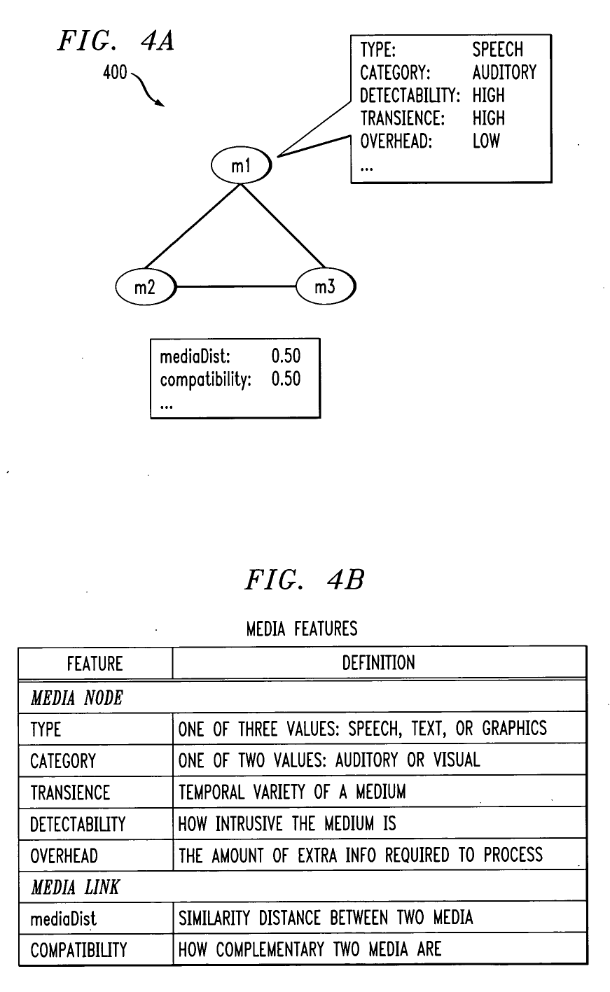

Referring now to FIG. 4A, a diagram illustrates a representation of a set of input media objects, according to one embodiment of the present invention. More particularly, FIG. 4A shows an example embodiment of a structure representing a set of available media objects. Each node denotes an available medium to be allocated, and each link captures the relationships between two media. Each node/link is annotated using relevant media features. Such annotation may be as described in the above-cited Y. Arens et al., “The Knowledge Underlying Multimedia Presentations,” Intelligent Multimedia Interfaces.

In FIG. 4A, node m1 has features such as type and transience. The link between m2 and m3 has features such as “mediaDist” (how similar two media are) and “compatibility” (how complementary two media are). While not limited thereto, FIG. 4B lists common media features that may be used by the system to characterize the properties of a media object. As an example embodiment, a media ontology may be defined to encode the feature values for each medium (e.g., detectability) and each pair of media (e.g., mediaDist).

Unlike a data graph, which is built from scratch during each turn of user interaction, a structure of media objects may be constructed during the system's initialization. That is, the information-seeking system (e.g., the system described in FIG. 1) creates a node for each available medium and extracts its features from data sources (e.g., a defined media ontology). The system also connects every two media nodes and computes the link features. During a user session, the system may update the structure of the media objects (e.g., deleting or adding a node), if the availability of a medium changes (e.g., graphics may become unavailable in a mobile application).

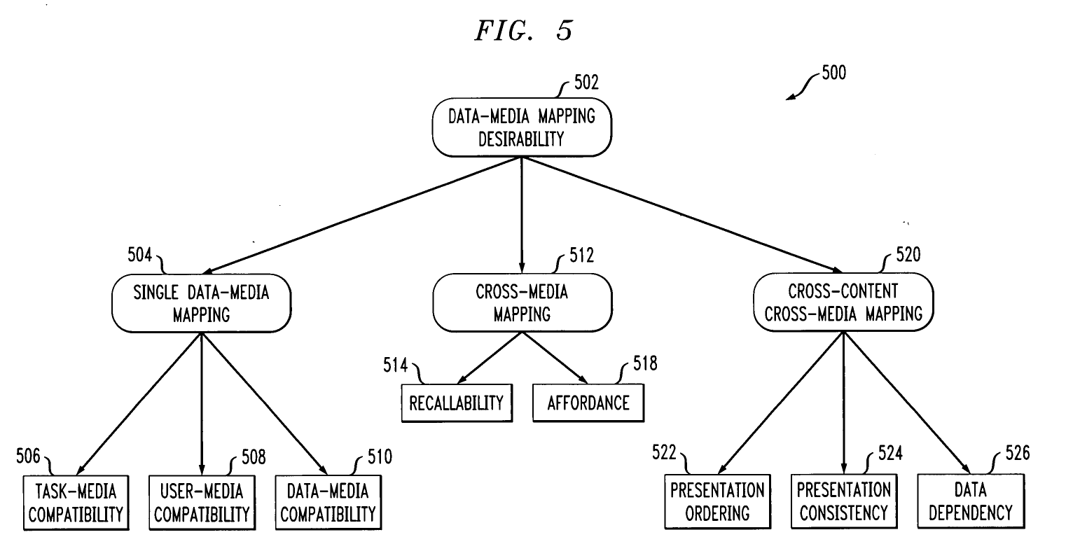

Referring now to FIG. 5, a diagram illustrates a process for modeling a data-media mapping desirability metric 502, according to one embodiment of the present invention. This hierarchical model 500 first measures the individual data-media mapping desirability 504 including task-media compatibility 506 (i.e., allocated media helps users to perform his/her intended tasks), user-media suitability 508 (i.e., allocated media are user preferred media), and data-media compatibility 510 (i.e., the allocated media are effective in conveying the intended data).

The model 500 then measures the cross-media data-media mapping desirability 512 (used to measure how desirable it is to use multiple media together to convey one data object) including recallability 514 (i.e., how well the presented data can be recalled by a user) and affordance 518 (i.e., how well the presented data can attract the user's attention).

When allocating media for multiple data objects, the model 500 also measures cross-content, cross-media mapping capability 520 including presentation ordering 522 (i.e., maintaining a presentation ordering of data), presentation consistency 524 (i.e., similar data presented similarly and the same data presented consistently during the entire course of interaction), and data dependency 526 (i.e., inter-dependent data presented coherently).

Each metric is modeled as a function of a set of parameters. We now describe the example metrics used in this illustrative implementation.

Task-Media compatibility

The metric is defined as:
T(mₜ,m)=1−mediaDist(mₜ,m) (1)
where mₜ is the medium (e.g., graphics) most suitable for achieving the task t (e.g., a comparison task), and m is a medium to be allocated for accomplishing this task. The function media distance measures how similar the two medium m, and m are. The closer these two media are, the more desirable is to choose medium m for accomplishing task t. In similar fashion, we can define every metric to measure how desirable is to use a medium to present a particular piece of data content.
User-Media Compatibility

An effective multimedia presentation must also be tailored to individual user preferences. For example, a user may indicate her media preferences explicitly in a profile or implicitly in a query, such as “show the airport” and “tell me about the city”. To assess how well a medium m matches a user preferred medium mᵤ, we define a user-media compatibility metric:
U(mᵤ,m)=1−mediaDist(mᵤ,m) (2)
The mediaDist function is similar to the one given above. This metric states that the shorter the distance between the two media is, the more similar the two media are. The two media are the same if their distance is 0.0.
Data-Media Compatibility

In addition to fulfilling presentation tasks and satisfying user preferences, we assign media that can best express the intended content using a data-media compatibility metric D(d, m). It uses two features: data-media suitability S(d, m) and capability C(d, m):
D(d,m)=S(d,m)×C(d,m) (3)
Here suitability assesses the effectiveness of using medium m to express d, while capability specifies the implemented capability of a media-specific designer. Now both suitability and capability values may be defined for each semantic category (e.g., spatial data) in a data ontology.

One way of combining equations 1-3 is to define a single metric to evaluate the desirability of selecting medium m for data d:
φ(d,m)=G[T(t,m), U(mᵤ,m), D(d,m)]
where function G could be any mathematical function, such as computing the average or simply taking the maximal value of the parameters.

The next two metrics are used to measure cross-media usage: presentation recallability and affordance. While recallability assesses how well a presented data item can be recalled, affordance measures how well the data item can catch a user's focus of attention.

Ensuring Recallability

The recallability of a presentation is directly affected by two media features: transience and overhead (as described in Y. Arens et al., “The Knowledge Underlying Multimedia Presentations,” Intelligent Multimedia Interfaces, chap. 12, pp. 280-306, 1993, the disclosure of which is incorporated by reference herein). Studies reveal that data items expressed by less-transient, lower-overhead media (e.g., text versus animation) are easier to recall. On the other hand, increasing data volume may reduce the recallability due to a user's limited working memory.

In practice, a proper mix of media is often used to increase the overall recallability of a presentation (e.g., written text accompanying speech). Studies however show that improper use of multiple media may compete for a user's attention. To avoid such situations, we define an overall compatibility across multiple media. Generally, we obtain a higher compatibility if complementary media are used. For example, text and speech are considered more compatible than text with graphics. Currently the compatibility of two media mᵢ and mⱼ can be defined manually. For example, text and speech are more compatible than text and graphics. The value is 1.0 if two media are fully complementary (e.g., text and speech).

Incorporating all features discussed above, the recallability for using a medium mᵢ to express d is:
R(d,mᵢ)=1−transience(mᵢ)×overhead(mᵢ)×volume(d).
Ensuring Affordance

An affordance metric evaluates how well a user can focus on the presented content. Two media features, detectability and overhead, (as referred to in Y. Arens et al., “The Knowledge Underlying Multimedia Presentations,” Intelligent Multimedia Interfaces, chap. 12, pp. 280-306, 1993, the disclosure of which is incorporated by reference herein) directly impact affordance. Normally, a medium with a higher detectability (e.g., speech versus written text) allows a user to notice the presentation more easily. A medium with a high overhead (e.g., animation) reduces the affordance, since it may distract the user. The affordance also drops when a low-detectable medium (e.g., text) is used to present a large volume of data. Using complementary media helps to gain proper affordance (e.g., speech accompanying graphics). However, we must avoid the use of multiple attention gaining media. To incorporate all factors mentioned here, we define the affordance metric of using medium mᵢ to convey data d:
A(d,mᵢ)=detectability(mᵢ)×[1−volume(d)]×[1−overhead(mᵢ)].

While the above two metrics regulate the usage of multiple media, the next set of metrics coordinate the media assignments across data items. Specifically, we define the metrics by three data relationships: data importance ordering, data dependency, and data similarity.

Maintaining Presentation Ordering

A proper presentation order aids users in comprehending the intended content. To establish such an order, we first constrain that important items be expressed effectively in their most compatible media (as given above). In addition, we require that the important items be easily recalled and attended to (as given above). To model these constraints, we formulate the presentation importance as the weight to promote more important items to be expressed more effectively:
φ_{w}(d,m)=importance(d)×φ(d,m), where m is the media assigned for d.

This metric is especially useful when presentation resources are limited (e.g., on a personal digital assistant or PDA), since it forces that the proper media be reserved for presenting the most important information.

Maintaining Data Dependency

Data dependency states that if data item A depends on item B, and A is selected to be presented, so is B. To maintain data dependency, similar media should be used to tie relevant data items together. Consider the effects where the city name is conveyed in speech but the boundary is expressed in graphics. In this case, the user must integrate both auditory (speech) and visual (graphics) channels to connect the two pieces of information.

We define a desirability metric to model the correlation between data dependencies and the corresponding media similarity. Given two data items dᵢ and dⱼ, and their corresponding assigned media mᵢ and m_{y}, if dᵢ and dⱼ are inter-dependent and mᵢ and m_{y} are similar, the overall desirability is high. Otherwise, the desirability is low:
ψ₁(dᵢ,dⱼ,mᵢ,mⱼ)=dependent(dᵢ,dⱼ)×sim(mᵢ,mⱼ) (4)
where data dᵢ, dⱼεD, mᵢ and mⱼ are the media used for dᵢ and dⱼ, respectively. Function dependent(dᵢ, dⱼ)=0.0, if the two elements are unrelated; otherwise, dependent(dᵢ, dⱼ)=1.0. Function sim(mᵢ, m_{y}) is defined using the media distance:
sim(mᵢ,mⱼ)=1−mediaDist(mᵢ, m_{y}). (a)
Maintaining Presentation Consistency

To maintain presentation consistency, we define a metric to model the correlations between data similarity and the corresponding media similarity. Similar to the data dependency metric, the consistency metric ensures a higher overall desirability, if any two similar items dᵢ, dⱼ are expressed by similar media mᵢ and mⱼ, the consistency score would be high:
ψ₂(dᵢ,dⱼ,mᵢ,mⱼ)=sim(dᵢ,dⱼ)×sim(mᵢ,mⱼ) (5)
where dᵢ, dⱼεD, mᵢ, mⱼεM and are the media chosen for dᵢ and dⱼ, respectively. Function sim(dᵢ, dⱼ) defines data similarity and sim(mᵢ, mⱼ) measures media similarity (see equation (a) above). The data similarity is computed using the semantic distance defined in a data ontology:
sim(dᵢ,dⱼ)=1−semanticDist(dᵢ,dⱼ).
In a continuous user-system interaction, another desired consistency criterion is that the same data be expressed consistently through the course of conversation. For example, the data attributes such as house price and style attributes that have been presented in the course of conversation, in the follow-up conversation, whenever possible these attributes should be conveyed consistently. We define a temporal consistency metric to regulate that every data item be expressed in the similar media during the course of an interaction:
ψ₃(dᵢ,mᵢ,mᵢ′)=sim(mᵢ,mᵢ′) (6)
where dᵢεD, mᵢεM is the media assigned to dᵢ now, and mᵢ′ is the media previously used for conveying dᵢ. Function sim(mᵢ, mᵢ′) measures media similarity (see equation (a) above).

Combining equations 4-6, we define a single formula to measure the cross-data media allocation desirability:
ψ(dᵢ,dⱼ,mᵢ,mⱼ)=Avg(ψₖ(dᵢ,mᵢ,mⱼ)), k=1 . . . 3.

Using these metrics above, an overall objective function is then defined to measure the overall desirability of a set of data-media mappings. Below is an example embodiment of such a function that combines the different desirability metrics together:

$${\sum }_{i} {\sum }_{x} P ( {d}_{i} , {m}_{x} ) \times ϕ ( {d}_{i} , {m}_{x} ) + {\sum }_{i} [ {\sum }_{x} P ( {d}_{i} , {m}_{x} ) \times R ( {d}_{i} , {m}_{x} ) ] \times compatibility ( {M}_{i} ) + {\sum }_{i} [ {\sum }_{x} P ( {d}_{i} , {m}_{x} ) \times A ( d , {m}_{x} ) ] \times compatibility ( {M}_{i} ) + {\sum }_{i} {\sum }_{j} {\sum }_{x} {\sum }_{y} P ( {d}_{i} , {m}_{x} ) \times P ( {d}_{j} , m ) ] \times ψ ( {d}_{i} , {d}_{j} , {m}_{x} , {m}_{y} ) \qquad ( 7 )$$

Here dᵢ, dⱼεD are the data to be presented, mₓ, m_{y}εM are the media assigned to dᵢ and dⱼ respectively, and M1 is a set of media assigned to convey data item dᵢ after iterating through all available media. Moreover, P(dᵢ, mₓ) and P(dⱼ, m_{y}) are the probabilities of assigning the corresponding media to the desired data elements. Metrics φ(dᵢ,mₓ), R(dᵢ,mₓ), A(d,mₓ), and ψ(dᵢ,dⱼ,mₓ,m_{y}) measure desirabilities for the overall single data-mapping, recallability, affordance, and for any given two data-media mappings, respectively.

It is to be understood the metrics as well as their according definitions (formulas) given above are merely examples used in this embodiment. The usage or type of metrics is not be limited to just those described above, nor do the definitions of such alternative metrics need to be as precise as those described herein.

Referring now to FIG. 6, a diagram illustrates a graph-matching methodology for performing media allocation, according to one embodiment of the present invention. More particularly, FIG. 6 shows an example embodiment of a graph-matching algorithm that obtains the desired media allocation results by maximizing the overall desirability of data-media mappings. This algorithm is performed, for example, by media allocation module 200 (FIG. 2). While not limited thereto, in this particular embodiment, a graduated assignment algorithm (as is known and, for example, described in S. Gold et al., “A Graduated Assignment Algorithm for Graph-Matching,” IEEE Trans. Pattern Analysis and Machine Intelligence, 18(4):377-388, 1996, the disclosure of which is incorporated by reference herein) is used to approximate the NP-complete graph-matching in O(n^{2×}m²). Here n and m are the total number of nodes in the data and media graphs, respectively.

Algorithm 600 first initializes the probabilities of media assignment for each data node. Specifically, the algorithm selects a medium that produces the highest data-media compatibility to initialize the probabilities.

During each iteration, algorithm 600 measures one or more data-media mapping desirability using the metrics that are described above (step 602). It then uses the gradient descent method (step 604) to increase the probabilities of assigning a medium to a data item in a small step. The algorithm then solves a media assignment Mᵢ for each dᵢ. If mₖεMᵢ is the most compatible medium for dᵢ, it is tagged as the primary medium for dᵢ; otherwise, as a supplementary one.

During each iteration, a total cost Scost(dᵢ, Mᵢ) is tested to determine whether it exceeds the allowed presentation budget. For example, in a real-estate information-seeking system application, using speech to utter a list of house prices may exceed the time budget, which limits how long a spoken output can last. When this occurs, the system has a choice: discard the offending medium or modify its usage to reduce the cost. The system may use media references to reduce the presentation cost. For example, the system may use speech to refer to the prices instead of describing them. In addition, these references help to make a better presentation. The speech reference improves the overall presentation affordance. To avoid repetitiveness in its responses (e.g., frequent spoken references), the system may randomly choose whether to discard the medium or to modify its usage.

When algorithm 600 eventually converges in step 606 (i.e., the gradient reaches a target threshold), a set of data-media mappings that maximizes the objective function and meet the presentation budget constraints is obtained.

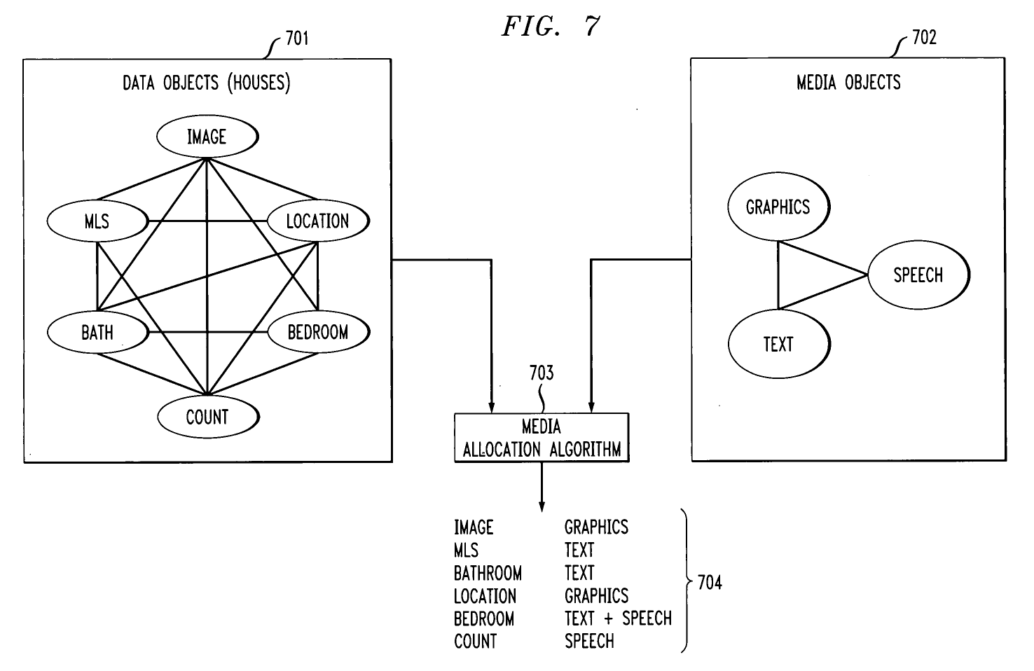

For example, as shown in FIG. 7, a set of data objects 701 to be presented may include a set of objects that describe a set of houses to be presented. For example, this may include the house location, image, multiple listing service (MLS) number, number of baths and bedrooms, and the total number of houses found (count) etc. FIG. 7 also shows a set of media objects 702 that are available for use to present this set of data objects. The media objects include speech, text, and graphics. Taking 701 and 702 as inputs, the inventive media allocation algorithm 703 (described in detail above in the context of FIG. 6) produces a set of data-media mappings 704.

In a set of mappings, for example, house location can be presented using graphics, house image can be presented using graphics, the number of bedrooms of the houses can be presented using text and speech, the number of bathrooms can be presented using text, and the count can be presented using speech. As a result of this set of data-media mappings, an example output presentation 800 of this set of houses is shown in FIG. 8.

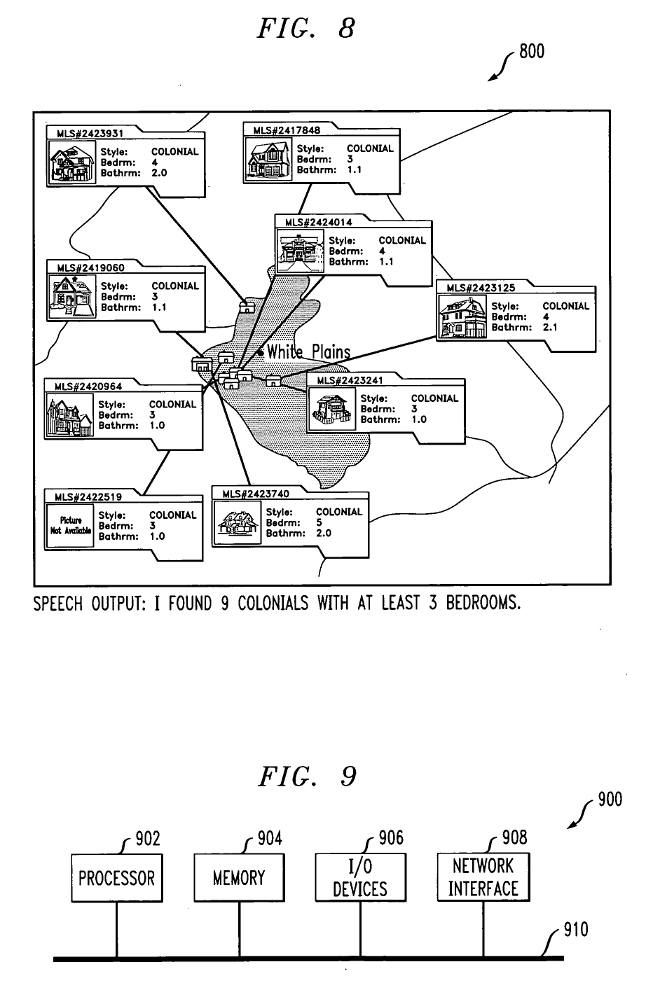

Referring lastly to FIG. 9, a diagram illustrates a computer system suitable for implementing an information-seeking system, according to one embodiment of the present invention. For example, the illustrative architecture of FIG. 9 may be used in implementing any and all of the components and/or steps described in the context of FIGS. 1 through 8.

As shown, the computer system 900 may be implemented in accordance with a processor 902, a memory 904, I/O devices 906, and a network interface 908, coupled via a computer bus 910 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

It is to be further appreciated that the present invention also includes techniques for providing media allocation services. By way of example, a service provider agrees (e.g., via a service level agreement or some informal agreement or arrangement) with a service customer or client to provide media allocation services. That is, by way of one example only, the service provider may host the customer's web site and associated applications. Then, in accordance with terms of the contract between the service provider and the service customer, the service provider provides media allocation services that may include one or more of the methodologies of the invention described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of allocating media to present data content for a response to a query, comprising the steps of:
determining data content suitable for generating a response to the query; and
dynamically allocating one or more media for presenting at least a portion of the response, wherein media allocation is modeled as an optimization operation which attempts to balance context-based allocation constraints and to achieve a desired presentation of intended information.

2. The method of claim 1, wherein the step of dynamically allocating one or more media further comprises modeling the context-based allocation constraints as feature-based desirability metrics.

3. The method of claim 2, wherein the step of dynamically allocating one or more media further comprises the step of one of the feature-based metrics measuring a task-media compatibility value.

4. The method of claim 2, wherein the step of dynamically allocating one or more media further comprises the step of one of the feature-based metrics measuring a user-media compatibility value.

5. The method of claim 2, wherein the step of dynamically allocating one or more media further comprises the step of one of the feature-based metrics measuring a data-media compatibility value.

6. The method of claim 2, wherein the step of dynamically allocating one or more media further comprises the step of one of the feature-based metrics measuring a recallability value.

7. The method of claim 2, wherein the step of dynamically allocating one or more media further comprises the step of one of the feature-based metrics measuring an affordance value.

8. The method of claim 2, wherein the step of dynamically allocating one or more media further comprises the step of the feature-based metrics measuring a presentation ordering value.

9. The method of claim 2, wherein the step of dynamically allocating one or more media further comprises the step of the feature-based metrics measuring a data dependency value.

10. The method of claim 2, wherein the step of dynamically allocating one or more media further comprises the step of the feature-based metrics measuring a presentation consistency value.

11. The method of claim 2, wherein the step of dynamically allocating one or more media further comprises the step of formulating the feature-based metrics using contextual information.

12. The method of claim 11, wherein the step of the feature-based metrics using contextual information further comprises the contextual information comprising at least one of query information, a conversation history, and a user model.

13. The method of claim 2, wherein the step of dynamically allocating one or more media further comprises the step of performing the optimization operation such that the desirability metrics are maximized for one or more data-media mappings.

14. The method of claim 13, wherein the optimization operation comprises a graph-matching or similar structure-matching technique.

15. Apparatus for allocating media to present data content for a response to a query, comprising:
a memory; and
at least one processor coupled to the memory and operative to determine data content suitable for generating a response to the query, and to dynamically allocate one or more media for presenting at least a portion of the response, wherein media allocation is modeled as an optimization operation which attempts to balance context-based allocation constraints and to achieve a desired presentation of intended information.

16. An article of manufacture for allocating media to present data content for a response to a query, comprising a machine readable medium containing one or more programs which when executed implement the steps of:
determining data content suitable for generating a response to the query; and
dynamically allocating one or more media for presenting at least a portion of the response, wherein media allocation is modeled as an optimization operation which attempts to balance context-based allocation constraints and to achieve a desired presentation of intended information.

17. A method of providing a service for allocating media to present data content for a response to a query, comprising the step of:
a service provider, in response to an obtained query, enabling the steps of determining data content suitable for generating a response to the query, and dynamically allocating one or more media for presenting at least a portion of the response, wherein media allocation is modeled as an optimization operation which attempts to balance context-based allocation constraints and to achieve a desired presentation of intended information.
